(19) United States
(12) Patent Application Publication
(10) Pub. No.: US 2016/0168667 A1
(43) Pub. Date: Jun. 16, 2016

(54) PROTECTIVE COATING AND GAS TURBINE COMPONENT HAVING SAID PROTECTIVE COATING

(71) Applicant: SIEMENS AKTIENGESELLSCHAFT, München (DE)

(72) Inventor: Xin-Hai Li, Linkoping (SE)

(73) Assignee: Siemens Aktiengesellschaft, Munich (DE)

(21) Appl. No.: 14/891,012

(22) PCT Filed: Apr. 22, 2014
(86) PCT No.: PCT/EP2014/058129

§ 371 Date: Nov. 13, 2015

(30) Foreign Application Priority Data
May 17, 2013 (DE) 10 2013 209 189.3

(51) Int. Cl. C22C 30/00; C23C 4/073; B32B 15/01

(52) U.S. Cl. CPC C22C 30/00; B32B 15/01; C23C 4/073

(57) ABSTRACT

A protective coating has 15 to 39 wgt.-% Co, 10 to 25 wgt.-% Cr, 5 to 15 wgt.-% AI, 0.05 to 1 wgt.-% Y, 0.5 to 10 wgt.-% Fe, the remainder Ni and impurities. A gas turbine component has this protective coating.

### CROSS REFERENCE TO RELATED APPLICATIONS

This application is the US National Stage of International Application No. PCT/EP2014/058129 filed Apr. 22, 2014, and claims the benefit thereof. The International Application claims the benefit of German Application No. DE 102013209189.3 filed May 17, 2013. All of the applications are incorporated by reference herein in their entirety.

### FIELD OF INVENTION

The invention relates to a protective coating for a gas turbine component.

### BACKGROUND OF INVENTION

A turbomachine, in particular a gas turbine, has a turbine in which hot gas, which has previously been compressed in a compressor and heated in a combustion chamber, is expanded in order to perform work. The higher the turbine inlet temperature of the hot gas, the higher the thermodynamic efficiency of the gas turbine. By contrast, there are limits as to the thermal loads which can be applied to the components of the gas turbine, in particular the guide vanes, the rotor blades and the casing.

It is therefore desirable to develop gas turbine components which, in spite of as high as possible a thermal load, have a sufficient chemical resistance for the operation of the gas turbine. It is known to apply a protective coating to the gas turbine components in order to protect the gas turbine components thereunder from oxidation and corrosion. Conventionally, the protective coating is made of an MCrAlX alloy, wherein M stands for nickel (Ni) and/or cobalt (Co) and X for example for yttrium (Y), rhenium (Re), gadolinium (Gd), lanthanum (La), platinum (Pt) and/or a rare earth metal. When applying the protective coating to the gas turbine component, the aluminum in the protective coating is oxidized and the resulting aluminum oxide binds well to the gas turbine component and protects it from oxidation and corrosion.

In the abovementioned elements, X represents elements which in recent years have seen a dramatic price increase, such that the conventional protective coatings are cost-intensive. In addition, inclusions of yttrium oxide in the aluminum oxide layer lead to a high diffusion rate of the oxygen, which results in faster oxidation of the protective coating. The oxidation of the protective coating leads to the gas turbine component thereunder being no longer protected, such that its service life is reduced.

### SUMMARY OF INVENTION

The invention has an object of producing a protective coating and a gas turbine component having said protective coating, wherein the protective coating is cost-effective and the gas turbine component has a long service life.

This object is achieved with the features of the independent claims. Further embodiments thereof are indicated in the further patent claims.

The protective coating according to the invention has 15 to 39 wt % cobalt (Co), 10 to 25 wt % chromium (Cr), 5 to 15 wt % aluminum (Al), 0.05 to 1 wt % yttrium (Y) and 0.5 to 10 wt % iron (Fe). According to the invention, the remainder is nickel (Ni) and unavoidable impurities.

Optional further constituents of the protective coating can moreover be Mo, Si, Ta and/or Hf.

The protective coating represents an effective protection from oxidation and corrosion. In addition, the protective coating is cost-effective due to its low proportion of high-value elements. The iron fraction in the protective coating also stabilizes aluminum-rich phases.

When applying the protective coating, or when the protective coating is exposed to hot gases, the aluminum oxide in the protective coating can be oxidized and an aluminum oxide layer forms on the surface of the protective coating. Because the yttrium content of the protective coating is low, only very few inclusions of yttrium oxide are formed in the aluminum oxide layer. As a consequence, only very little oxygen can be transported into the protective coating, such that the protective coating has a long service life.

Advantageously, the protective coating has 0.05 to 2 wt % molybdenum (Mo). It is advantageous for the protective coating to have 0 to 4 wt % silicon (Si). The protective coating in particular has 0 to 2 wt % tantalum (Ta). It is further advantageous for the protective coating to have 0 to 2 wt % hafnium (Hf).

The fraction of sulfur (S) in the protective coating is in particular less than or equal to 8*10⁻⁶ wt %. This advantageously further increases the service life of the protective coating.

Moreover, the invention relates to the use of an above-described protective coating for a gas turbine component, in particular for a turbine blade or a combustion chamber component.

The gas turbine component according to the invention has the protective coating. The gas turbine component in particular has a substrate onto which the protective coating is applied, wherein the substrate is made of a nickel-based superalloy and/or a cobalt-based superalloy. By virtue of the provision of the protective coating, the gas turbine component has a long service life in operation of the gas turbine. The protective coating in particular has a thickness of 30 μm to 800 μm.

The protective coating is in particular applied to the substrate by means of a thermal spraying method, in particular in air, in vacuo or under a protective gas, and/or by means of a physical deposition method (physical vapor deposition—PVD).

An embodiment of the gas turbine component according to the invention is explained below with reference to the appended schematic drawing.

### BRIEF DESCRIPTION OF THE DRAWINGS

The FIGURE shows a section through the embodiment.

### DETAILED DESCRIPTION OF INVENTION

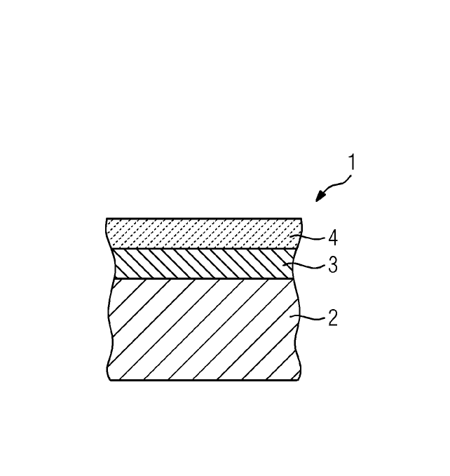

As shown in FIG. 1, a gas turbine component 1 has a substrate 2, a protective coating 3 and a ceramic layer 4. The substrate 2 is for example a guide vane or a rotor blade in the turbine of a gas turbine. In that context, the substrate 2 is made of a nickel-based superalloy or of a cobalt-based superalloy.

The protective coating 3 having a thickness of 30 μm to 800 μm is applied directly onto the substrate 2. In that context, the protective coating 3 is applied to the substrate 2 by means of a thermal spraying method or a physical deposition method, with a composition of 15 to 39 wt % Co, 10 to 25 wt % Cr, 5 to 15 wt % Al, 0.05 to 1 wt % Y, 0.5 to 10 wt % Fe, 0.05 to 2 wt % Mo, 0 to 4 wt % Si, 0 to 2 wt % Ta, 0 to 2 wt % Hf and as remainder Ni and impurities. In terms of the impurities, the fraction of sulfur S is less than or equal to 8*10⁻⁶ wt %.

Oxidation of the aluminum produces, on that surface of the protective coating 3 oriented away from the substrate 2, an aluminum oxide layer which protects the substrate 2 from oxidation and corrosion. Directly on top of the protective coating 3, there is arranged a ceramic layer 4 which for example has zirconium oxide or zirconium oxide stabilized with yttrium oxide.

The invention is explained in more detail below with reference to multiple examples.

A first exemplary protective coating 3 has 20 wt % Co, 20 wt % Cr, 10 wt % Al, 0.1 wt % Y, 5 wt % Fe and 44.9 wt % Ni and relatively small quantities of impurities.

A second exemplary protective coating 3 has 30 wt % Co, 15 wt % Cr, 15 wt % Al, 0.3 wt % Y, 8 wt % Fe, 1 wt % Mo and 30.7 wt % Ni and relatively small quantities of impurities.

A third exemplary protective coating 3 has 12 wt % Co, 12 wt % Cr, 15 wt % Al, 0.5 wt % Y, 10 wt % Fe, 1 wt % Mo, 3 wt % Si, 0.5 wt % Ta, 0.5 wt % Hf and 45.5 wt % Ni and relatively small quantities of impurities.

In three exemplary gas turbine components, the three exemplary protective coatings are in each case applied by means of a thermal spraying method onto a substrate made of a nickel-based superalloy.

1. A protective coating having
15 to 39 wt % Co,
10 to 25 wt % Cr,
5 to 15 wt % Al,
0.05 to 1 wt % Y,
0.5 to 10 wt % Fe,
optionally Mo, Si, Ta and/or Hf,
remainder Ni and impurities.

2. The protective coating as claimed in claim 1,
wherein the protective coating has 0.05 to 2 wt % Mo.

3. The protective coating as claimed in claim 1,
wherein the protective coating has 0 to 4 wt % Si.

4. The protective coating as claimed in claim 1,
wherein the protective coating has 0 to 2 wt % Ta.

5. The protective coating as claimed in claim 1,
wherein the protective coating has 0 to 2 wt % Hf.

6. The protective coating as claimed in claim 1,
wherein the fraction of sulfur in the protective coating is less than or equal to 8*10⁻⁶ wt %.

7. A gas turbine component having
the protective coating as claimed in claim 1.

8. The gas turbine component as claimed in claim 7,
wherein the gas turbine component has a substrate onto which the protective coating is applied,
wherein the substrate is made of a nickel-based superalloy and/or a cobalt-based superalloy.

9. The gas turbine component as claimed in claim 7,
wherein the protective coating has a thickness of 30 μm to 800 μm.

10. The gas turbine component as claimed in claim 8,
wherein the protective coating is applied to the substrate by means of a thermal spraying method and/or by means of a physical deposition method.

11. The gas turbine component as claimed in claim 10,
wherein the thermal spraying method is in air, in vacuo or under a protective gas.
